(19) United States
(12) Patent Application Publication
(10) Pub. No.: US 2004/0052448 A1
(43) Pub. Date: Mar. 18, 2004

(54) Analogue-to-digital conversion arrangement

(76) Inventor: Robert Anthony Griffin, Northants (GB)

Correspondence Address: FLESHNER & KIM, P.O. BOX 221200, CHANTILLY, VA, 20153-1200, US

(21) Appl. No.: 10/240,211

(22) PCT Filed: Mar. 14, 2001
(86) PCT No.: PCT/GB01/01129

(30) Foreign Application Priority Data
Mar. 29, 2000 (GB) 0007488.0

(51) Int. Cl. G02B 6/293

(52) U.S. Cl. 385/24

(57) ABSTRACT

An analogue-to-digital conversion arrangement employs a CW laser, which is ramped in wavelength over a given wavelength range for a given time, to drive a modulator whose modulating input is an analogue signal to be converted. The modulator feeds wavelength-splitter having a number of channels centered on different wavelengths within the wavelength range, the outputs of these channels being converted into respective analogue electrical signals, conventional ADCs being finally used to convert these signals in turn into digital signals.

The invention relates to an analogue-to-digital conversion arrangement, and in particular, but not exclusively, an analogue-to-digital conversion arrangement for converting very high speed analogue signals to digital form, and a method for converting an input electrical analogue signal to an electrical digital signal.

Conventionally, analogue electrical signals are converted into digital form using one of the known electrical analogue-to-digital conversion (ADC) techniques, which include, purely as examples, dual-ramp, charge-balancing, successive-approximation and flash-conversion arrangements. In all these methods there is a limit to the rate at which digital values can be formed from the input analogue signal. In the slower methods (virtually all except the flash converter) time must be allowed for the required integration or approximation processes to take place, this time being provided by a suitable sample-and-hold arrangement which freezes the input while it is being operated on. In the case of flash conversion, which is normally the fastest variety, although there is no sample-and-hold operation, there are still the unavoidable propagation delays associated with the various stages of the converter. These speed limits from whatever cause determine the maximum sampling rate that can be achieved.

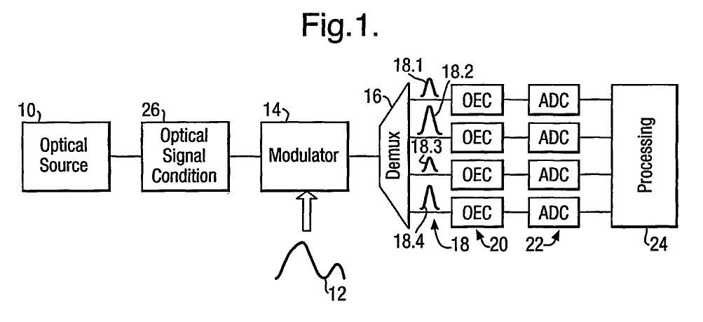

There is, however, a need for an ADC system which can provide an adequate number of digitised samples of an analogue signal lasting for only a short period, e.g. of the order of nanoseconds. This has been found to be extremely difficult to achieve using an electrical ADC by itself and supplementary measures have been taken in the past in an attempt to approach the required performance. One such system is disclosed in the journal “Electronics Letters”, vol. 33, 1997, pages 2096-2097 and is illustrated in broad schematic terms in FIG. 1. In this system the light from an optical source 10 (in practice a laser) is, after undergoing a signal-conditioning process 26, intensity-modulated by an electrical signal 12 in a modulator 14 and the resultant modulated light signal is taken to a wavelength-splitting device 16 which is designed to derive a number of channels 18 each centred on a different wavelength. The laser 10 is in this arrangement a pulsed laser and the signal conditioning in stage 26, which includes a polarising beam splitter and a highly dispersive fibre lightguide, is for the purpose of separating out in time the different frequency components making up the single pulse delivered by the laser. Finally, the signals on the various channels 18 are converted into electrical form in respective opto-electrical converters 20, the resulting analogue electrical signals are converted into digital form in conventional electrical ADCs 22 and the resulting digital signals are processed in a suitable processing means 24.

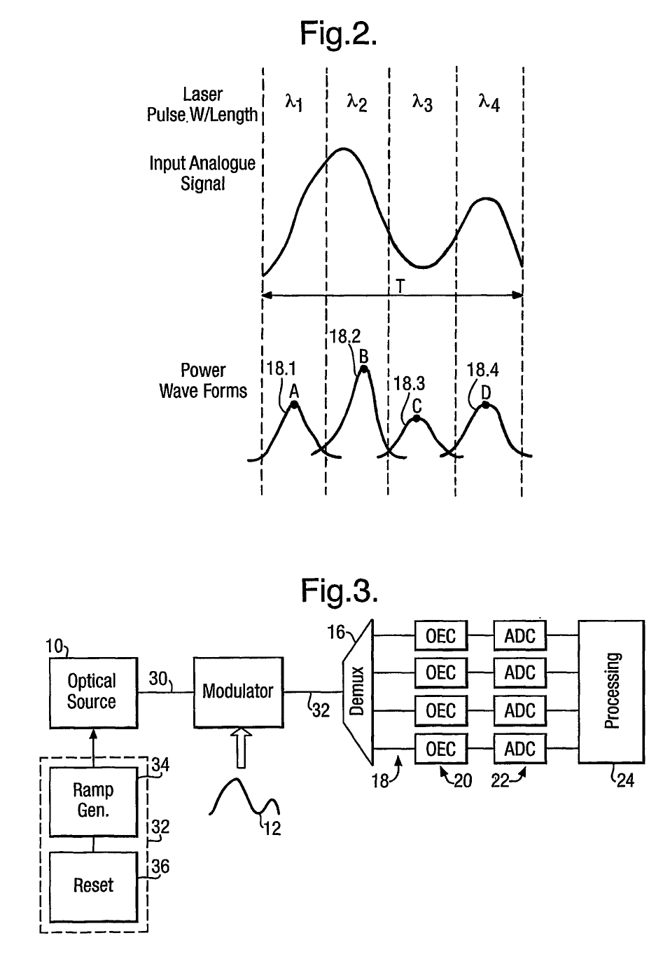

The effect of the splitting operation is to produce a number of “slices” of the input analogue signal 12, as shown in FIG. 2. In FIG. 2 it is assumed that signal 12 occupies a time duration T and that the laser delivers in this example four pulses at consecutive wavelengths λ₁, λ₂, λ₃, λ₄ over time T. The opto-electrical converters 20 and ADCs 22 form a measure of the optical power in their respective channels 18, which channels are operating at the respective wavelengths λ₁-λ₄.

The effect of this whole process is that, although the ADCs 22 sample only once during time T, it is as though the input analogue waveform 12 is being sampled n times, where n is the number of channels (in this example, four). Thus there occurs an apparent increase (by a factor n) of the sampling speed of the conventional ADCs 22.

A major drawback with this system is the very high cost of the laser arrangement used, due mainly to its complexity.

In accordance with a first aspect of the invention there is provided an analogue-to-digital conversion arrangement comprising: an optical source for delivering continuous-wave radiation at a wavelength which is variable with time over a given wavelength range; a modulating means having a first input coupled to the optical source, a second input coupled to a electrical modulating source, and an optical output; a wavelength-splitting means coupled to the output of the modulating means for providing a plurality of output channels, the channels being centred on respective different wavelengths contained within said wavelength range; and an electrical analogue-to-digital converter means coupled to the outputs of the wavelength-splitting means.

Under a second aspect there is provided a method for converting an input electrical analogue signal to an electrical digital signal, comprising: varying the wavelength of a source of continuous-wave optical radiation over a predetermined time period and over a given range; modulating the intensity of the wavelength-varied radiation by the input electrical analogue signal; splitting the modulated radiation into a plurality of channels centred on respective wavelengths within said wavelength range; converting the optical signals in the plurality of channels into respective analogue electrical signals; and converting these analogue electrical signals into respective digital signals.

The predetermined time period may be continuously repeated.

The electrical analogue-to-digital converter means preferably comprises one converter for each channel. The outputs of the converters may be read individually in said time period in an order which is related to the respective temporal positions of said channel wavelengths in said wavelength range. The order may be sequential from one extreme channel wavelength to the other.

Each analogue-to-digital converter may be arranged to sample a quantity relating to the signal at its input once during said predetermined time period.

The optical source is advantageously a laser, whose wavelength may be ramped continuously over said predetermined time period. The ramp may be substantially linear.

The outputs of the electrical analogue-to-digital converters may be taken to a parallel-to-serial converter for providing serial digital signals for further processing.

The modulating means may be a Mach-Zehnder modulator.

The wavelength-splitting means may be coupled to the electrical analogue-to-digital converter means by way of a photodiode arrangement. The wavelength-splitting means may be a diffraction-grating arrangement or an arrayed-waveguide grating arrangement.

An embodiment of the invention will now be described, by way of example only, with the aid of the drawings, of which:

FIG. 1 is a schematic diagram of a prior ADC arrangement;

FIG. 2 is a waveform diagram relating to the prior ADC arrangement of FIG.

FIG. 3 is a schematic diagram of an embodiment of an ADC arrangement in accordance with the invention;

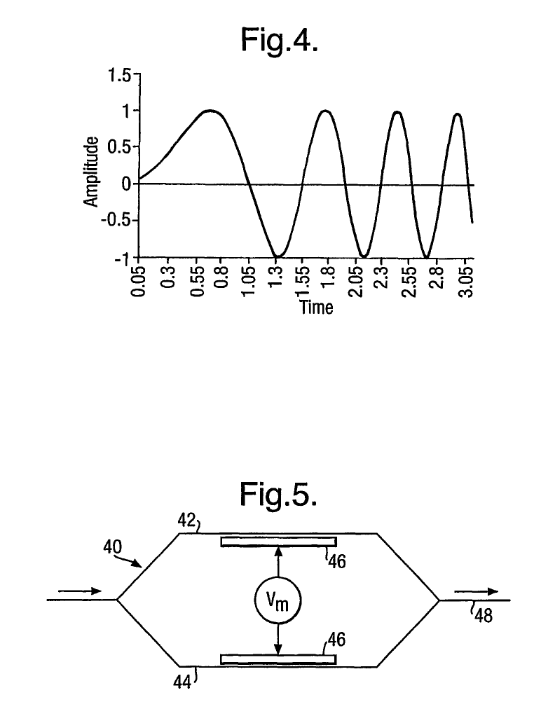

FIG. 4 shows a linearly chirped carrier signal;

FIG. 5 is a schematic representation of a Mach-Zehnder modulator;

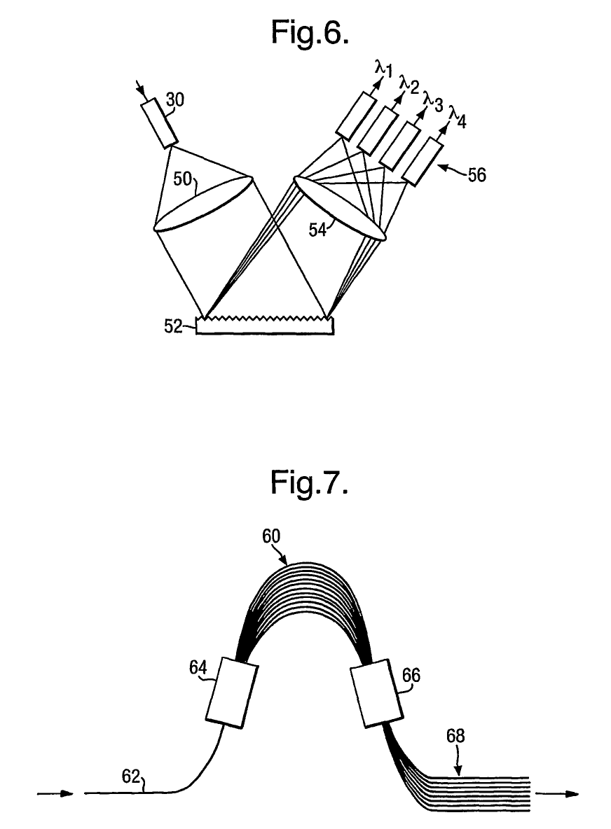

FIG. 6 shows the principle of operation of a first wavelength-splitter device which may be employed in an embodiment of the invention, and

FIG. 7 is a schematic diagram of a second wavelength-splitter device which may be employed in an embodiment of the invention.

Referring now to FIG. 3, in which items which correspond to similar items shown in FIG. 1 are given the same reference numeral, the output radiation from an optical source 10 in the form of a laser is propagated along a lightguide 30 to a modulator 14, is modulated as before by an input electrical analogue signal 12 and the resultant modulated signal is propagated along a further lightguide 32 to the wavelength splitter 16, which as before outputs a series of channels 18 centred on different wavelengths. The optical content of the signals on these channels is, again, converted into analogue electrical form in converters 20, these analogue electrical signals in turn are converted into digital form in ADCs 22 and the digital signals processed in processing means 24.

It should be noted that, for the sake of simplicity, only four channels 18 are shown in FIG. 3, whereas in practice there may be a higher number, e.g. eight or even sixteen.

In this arrangement, however, the optical source (laser) is not a pulsed device, but a continuous-wave (CW) device which has its wavelength continuously varied over the time duration T (see FIG. 2). In addition the signal-conditioning stage 26 in FIG. 1 is redundant. In the preferred embodiment of the invention the wavelength is linearly varied from, say, a lower frequency limit to a higher frequency limit, as illustrated very schematically in FIG. 4. The laser output is said to be “chirped”. To achieve this chirping, the laser is controlled by a control circuit 32 containing a ramp generator 34 and a reset means 36. The ramp generator causes the wavelength to change gradually from a starting value to a finishing value, while the reset means determines the point at which chirping ceases and the laser relaxes to its original starting wavelength. The reset means may be, for example, a timer which allows ramping to stop after time T or a wavelength detector set to detect when the finishing wavelength has been reached, upon which the ramp generator is reset. In either case the exact control design chosen will ensure that the wavelength is ramped over a suitable range over the desired time period T.

Possibly the most straightforward ramping arrangement is a single-shot arrangement in which the laser wavelength “idles” outside the desired wavelength band until the ramp generator is triggered to sweep through the required wavelengths. An alternative method is to arrange for ramping and resetting operations to occur on a repetitive basis, which may allow continuous digitisation of a high-frequency signal in real time. It is noted that the channels 18 provide information about the signal in parallel, each channel corresponding to a different portion of the overall time T. In the processing means 24 the outputs of the ADCs 22 may be serialised by being fed in parallel into a digital parallel-serial register which, by the input of a suitable clock signal, outputs the different digital values in sequence. The sequence will in this case be in strict time order so that the end result is an accurate reflection of the temporal behaviour of the signal 12. Alternatively, the ADC outputs may be fed into a parallel-serial device which is capable of outputting the digital values in any desired order. This would then constitute a way of modifying the digital version of the signal 12. One such modification which is conceivable is to simply reverse the order of the digital values so that a lateral inversion (temporal mirror image) of the signal 12 is achieved.

As an alternative to starting low and finishing high, ramping may be such that the starting frequency is high and ramping is in a downwards direction, relaxation being then back to the high-frequency limit. This could apply to both the one-shot and repetitive schemes. It is also conceivable to arrange for ramping to be in both directions alternately. Thus ramping may start from the low frequency limit up to the high, then proceed from the high frequency limit down to the low. A potential drawback with this, however, is that there would be an overlap of signal samples near the top and bottom of the ramp, which would lead to difficulties in processing the data.

A preferred ramping scheme is to interlace two units A and B, such that, while unit A is ramping over period T, unit B is turning off while it recovers to the start wavelength and while unit B is ramped, unit A is turned off to recover to the start wavelength.

The optical-to-electrical converters 20 are advantageously photodiodes, though alternative devices are possible, e.g. avalanche photodiodes or phototransistors.

The ADCs 22 will ideally sample the signals at the outputs of the converters 20 at the peaks A, B, C, D of their respective waveforms (see FIG. 2). In practice, however, the detected waveforms may be band-limited or integrated over a time period T and sampled by an ADC with bandwidth 1/T. The resulting sample is equivalent to a sample of the peak waveform, since integrated power is proportional to peak power. A suitable device for the modulator 14 is the Mach-Zehnder modulator illustrated in simplified schematic form in FIG. 5. This device comprises a “Y” arrangement of waveguides 40 having one the faces of the two limbs 42, 44 electrodes 46 which are driven by the modulating signal Vₘ. If the modulating signal is allowed to vary the relative phases of the potentials on the electrodes, then there will be a summing or cancelling effect in the combination of the two limb signals in the output part of the waveguide 48. Normally the quiescent phase-difference between the electrodes is 180°.

The wavelength-splitter 16 may be realised as a conventional diffraction grating or as an arrayed-waveguide grating wavelength multiplexer. The principle of operation of the former is shown in FIG. 6, while that of the latter is shown in FIG. 7.

In FIG. 6 the incoming light from the laser is fed along the lightguide 30 and through a lens 50 to strike a diffraction grating 52. Light scattered from the grating 52 is passed through a further lens 54 to a series of lightguides 56 which correspond to the channels 18 in FIG. 3. This arrangement relies on the wavelength-related dispersion that is undergone by the incident light, the lightguides 56 being spaced apart by an amount which is dictated by the desired channel wavelength spacing (Δλ).

The alternative scheme in FIG. 7 utilises a so-called arrayed waveguide grating (AWG) which consists of a series of waveguides 60 whose lengths differ by a constant value. The incoming light (the modulated chirp signal) is led along a lightguide 62 into a coupling member 64, in which it is diffracted, and thence into the AWG at one end. The light exits the AWG at the other end and passes via a second coupling member 66, in which the light is converged, into a series of output lightguides 68. The input light from the first coupling member 64 enters the guides 60 in the same phase, but undergoes a differential phase shift in the AWG due to the different lengths of the guides 60, so that the wavefront of the light entering the second coupling member 66 is tilted. Thus the position of convergence of the light in the second coupling member is a function of wavelength, with the result that light of different wavelengths is propagated along different ones of the output lightguides 68.

Whichever wavelength-splitting technique is employed, the channel wavelengths should be within the range of wavelengths that the laser is outputting through the ramping process.

The use of a CW and preferably linearly chirped laser in an embodiment of the invention enables the laser system and associated drive circuitry to be realised in a simple and cost-effective way. The chirped CW laser and modulator may conveniently be integrated and remotely located at the source of the signal to be digitised. Larger and less robust optical sources cannot be remotely located, leading to difficulties in coupling power between the laser system and the optical modulator. The correct operation of available modulators requires that the input optical state of polarisation be strictly controlled, requiring further expense and complexity in the form of polarisation-maintaining components when the laser and modulator are separated by substantial distances. Thus the use of a CW source avoids this complexity and expense.

The chirped CW source is amenable to optical sampling operations where the system is triggered at arbitrary time instants to provice single-shot or repetitive samples. In addition, the use of a chirped CW source allows high output power to be achieved at the output of the demultiplexer 16. The amount of optical power may determine the system signal-to-noise ratio and thus the minimum resolution of the system, hence higher power will lead to improved performance. For the CW case, the time-wavelength variation is generated directly within the laser and no further signal conditioning, as provided by stage 26 in FIG. 1, is required, hence the large optical losses associated with conditioning a pulsed output are avoided. Further, since the power is evenly distributed over period T, the CW laser may be optically amplified to further increase power without the generation of undesired optical nonlinear effects which can result from high peak powers.

1. Analogue-to-digital conversion arrangement comprising: an optical source for delivering continuous-wave radiation at a wavelength which is variable with time over a given wavelength range; a modulating means having a first input coupled to the optical source, a second input coupled to a electrical modulating source, and an optical output; a wavelength-splitting means coupled to the output of the modulating means for providing a plurality of output channels, the channels being centred on respective different wavelengths contained within said wavelength range; and an electrical analogue-to-digital converter means coupled to the outputs of the wavelength-splitting means.

2. Analogue-to-digital conversion arrangement as claimed in claim 1, wherein the wavelength of the optical source is variable over the given range during a predetermined time period.

3. Analogue-to-digital conversion arrangement as claimed in claim 2, wherein the predetermined time period is continuously repeated.

4. Analogue-to-digital conversion arrangement as claimed in claim 2 or claim 3, wherein the electrical analogue-to-digital converter means comprises one converter for each channel.

5. Analogue-to-digital conversion arrangement as claimed in claim 4, wherein the outputs of the electrical analogue-to-digital converters are read individually in said time period in an order which is related to the respective temporal positions of said channel wavelengths in said wavelength range.

6. Analogue-to-digital conversion arrangement as claimed in claim 5, wherein said order is sequential from one extreme channel wavelength to the other.

7. Analogue-to-digital conversion arrangement as claimed in any one of claims 4 to 6, wherein each analogue-to-digital converter is arranged to sample a quantity relating to the signal at its input once during said predetermined time period.

8. Analogue-to-digital conversion arrangement as claimed in any one of claims 4 to 7, wherein the optical source is a laser.

9. Analogue-to-digital conversion arrangement as claimed in claim 8, wherein the laser wavelength is ramped continuously over said predetermined time period.

10. Analogue-to-digital conversion arrangement as claimed in claim 9, wherein the ramp is a substantially linear ramp.

11. Analogue-to-digital conversion arrangement as claimed in any one of claims 4 to 10, wherein the outputs of the electrical analogue-to-digital converters are taken to a parallel-to-serial converter for providing serial digital signals for further processing.

12. Analogue-to-digital conversion arrangement as claimed in any one of the preceding claims, wherein the modulating means is a Mach-Zehnder modulator.

13. Analogue-to-digital conversion arrangement as claimed in any one of the preceding claims, wherein the wavelength-splitting means is coupled to the electrical analogue-to-digital converter means by way of a photodiode arrangement.

14. Analogue-to-digital conversion arrangement as claimed in any one of the preceding claims, wherein the wavelength-splitting means is a diffraction-grating arrangement or an arrayed-waveguide grating arrangement.

15. Analogue-to-digital conversion arrangement substantially as shown in, or as herebefore described with reference to, FIG. 3 and FIG. 6 or Figure and FIG. 7.

16. Method for converting an input electrical analogue signal to an electrical digital signal, comprising: varying the wavelength of a source of continuous-wave optical radiation over a predetermined time period and over a given range; modulating the intensity of the wavelength-varied radiation by the input electrical analogue signal; splitting the modulated radiation into a plurality of channels centred on respective wavelengths within said wavelength range; converting the optical signals in the plurality of channels into respective analogue electrical signals; and converting these analogue electrical signals into respective digital signals.

17. Method as claimed in claim 16, wherein the digital signals are supplied as a serial stream for further processing.

18. Method as claimed in claim 17, wherein the digital signals are supplied as a serial stream during said predetermined time period.

19. Method substantially as herebefore described.
